(19) United States
(12) Patent Application Publication
(10) Pub. No.: US 2015/0101767 A1
(43) Pub. Date: Apr. 16, 2015

(54) NON-CORD WINDOW BLIND ASSEMBLY

(71) Applicant: Chin-Fu CHEN, Taichung City (TW)

(72) Inventor: Po-Yu CHEN, Taichung City (TW)

(73) Assignee: Chin-Fu CHEN, Taichung City (TW)

(21) Appl. No.: 14/254,623

(22) Filed: Apr. 16, 2014

(30) Foreign Application Priority Data
Oct. 11, 2013 (TW) 102136869

(51) Int. Cl. E06B 9/327; E06B 9/322

(52) U.S. Cl. CPC E06B 9/327; E06B 9/322; E06B 2009/3222
USPC 160/370

(57) ABSTRACT

A non-cord window blind assembly includes two opposing side jambs each defining a longitudinal guide groove and a plurality of oblique positioning grooves respectively connected to and equally spaced along the longitudinal guide groove, and a blind coupled between the side jambs and including a headrail, a bottom rail and a panel of cellular material coupled between the headrail and the bottom rail. The bottom rail has two guide rods respectively located at two opposite ends thereof and respectively slidably coupled to the guide grooves of the side jambs and respectively selectively positionable in one respective oblique positioning groove of one respective side jamb.

### BACKGROUND OF THE INVENTION

1. Field of the Invention

The present invention relates to window blind technology, and more particularly to a non-cord window blind assembly.

2. Description of the Related Art

Commercial window blinds can be classified into pull-cord window blinds and non-cord window blinds. A pull-cord window blind uses a pull cord for pulling to move the blind between an extended status and a received status. A non-cord window blind allows a user to pull down or lift the bottom rail, causing a transmission mechanism to move the blind between an extended status and a received status.

Exemplars of non-cord window blinds are seen in Taiwan Patent Publication Number 263877 entitled “Non-cord window blind control device” and Taiwan Patent Publication Number 322458 entitled “Actuation structure for actuating cord of curtain without cord”. These two prior art patents provide approaches to improvement of blind transmission mechanism. However, the structural designs of these two prior art patents are complicated, and will cause an assembly problem and increase the cost.

### SUMMARY OF THE INVENTION

The present invention has been accomplished under the circumstances in view. It is the main object of the present to provide a non-cord window blind assembly, which has a simple structure and is easy to operate, and can effectively reduce the manufacturing cost and enhance user convenience.

To achieve this and other objects of the present invention, a non-cord window blind assembly of the invention comprises two side jambs and a blind. The two side jambs are arranged in a mirror-symmetric manner, each comprising a guide groove extending along the length thereof and a plurality of oblique positioning grooves equally spaced along the length thereof and respectively connected to the guide groove. The blind is coupled between the side jambs, comprising a headrail, a bottom rail and a panel of cellular material connected between the headrail and the bottom rail. The bottom rail comprises two guide rods respectively located at two opposite ends thereof and respectively slidably coupled to the guide grooves of the side jambs and respectively selectively positionable in one respective oblique positioning groove of one respective side jamb.

Preferably, each guide rod of the bottom rail is mounted with one respective pulley that is rotatably coupled to the guide groove of one respective side jamb and selectively positionable in one oblique positioning groove to enhance the smoothness and stability of the movement of the bottom rail.

Preferably, two opposite sides of said blind and said two side jambs are respectively accommodated in two outer frames so that the outer frames can prevent the panel of cellular material from turning over after positioning. Further, a spring member is mounted in each outer frame. Further, each side jamb is affixed to the spring member in one respective outer frame. Thus, the gap between each side jamb and the respective outer frame is adjustable by fastening tight or loosening the respective screw.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an oblique top elevational view of a non-cord window blind assembly in accordance with a first embodiment of the present invention.

FIG. 2 is an exploded view of the non-cord window blind assembly in accordance with the first embodiment of the present invention.

FIG. 3 is an exploded view of a part of the non-cord window blind assembly in accordance with the first embodiment of the present invention.

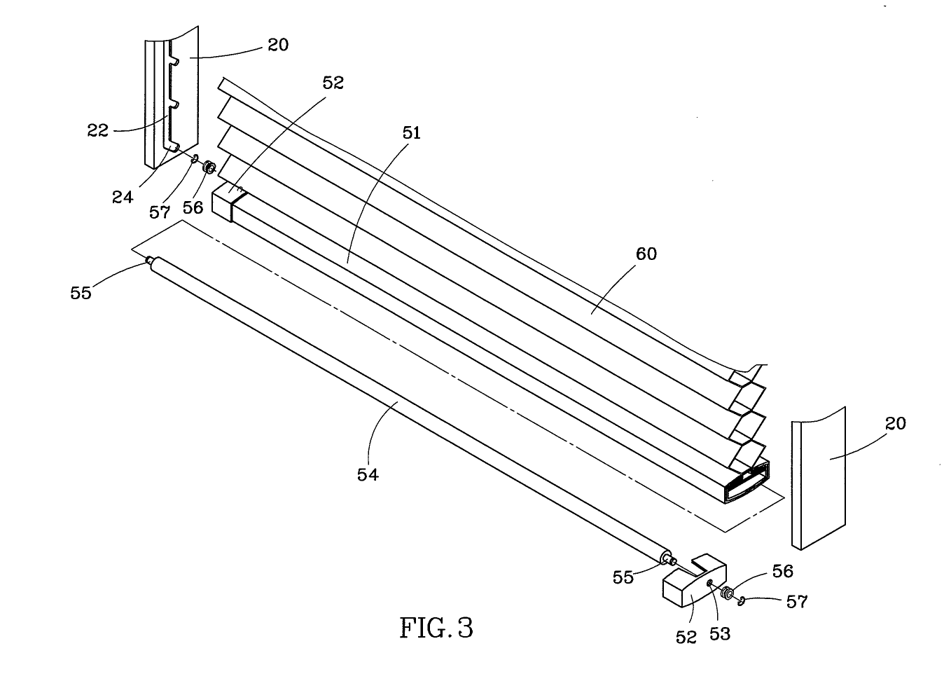

FIG. 4 is a sectional view of a part of the non-cord window blind assembly in accordance with the first embodiment of the present invention.

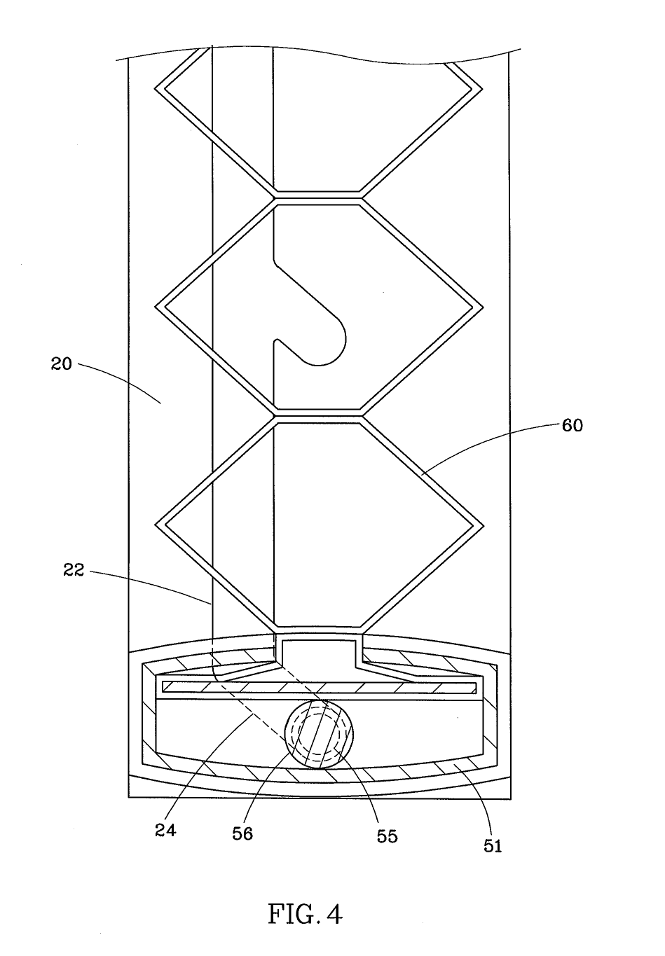

FIG. 5 is a schematic elevational view of the first embodiment of the present invention, illustrating the blind of the non-cord window blind assembly in a received condition.

FIG. 6 is a sectional side view of a part of the non-cord window blind assembly in accordance with the first embodiment of the present invention.

FIG. 7 is an exploded view of a part of a non-cord window blind assembly in accordance with a second embodiment of the present invention.

FIG. 8 is a top view of a part of a non-cord window blind assembly in accordance with a third embodiment of the present invention.

### DETAILED DESCRIPTION OF THE INVENTION

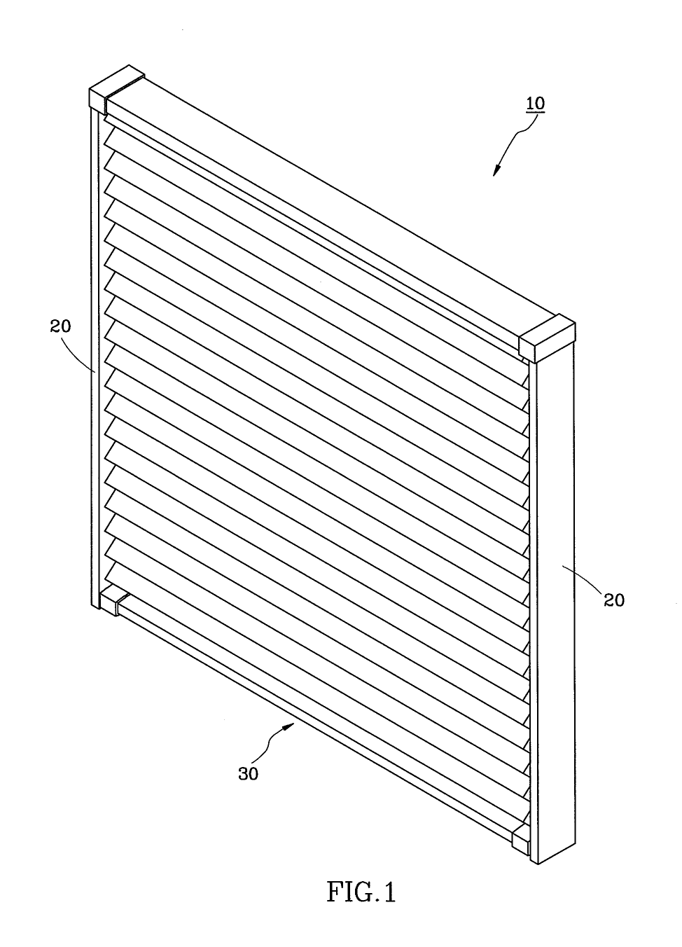

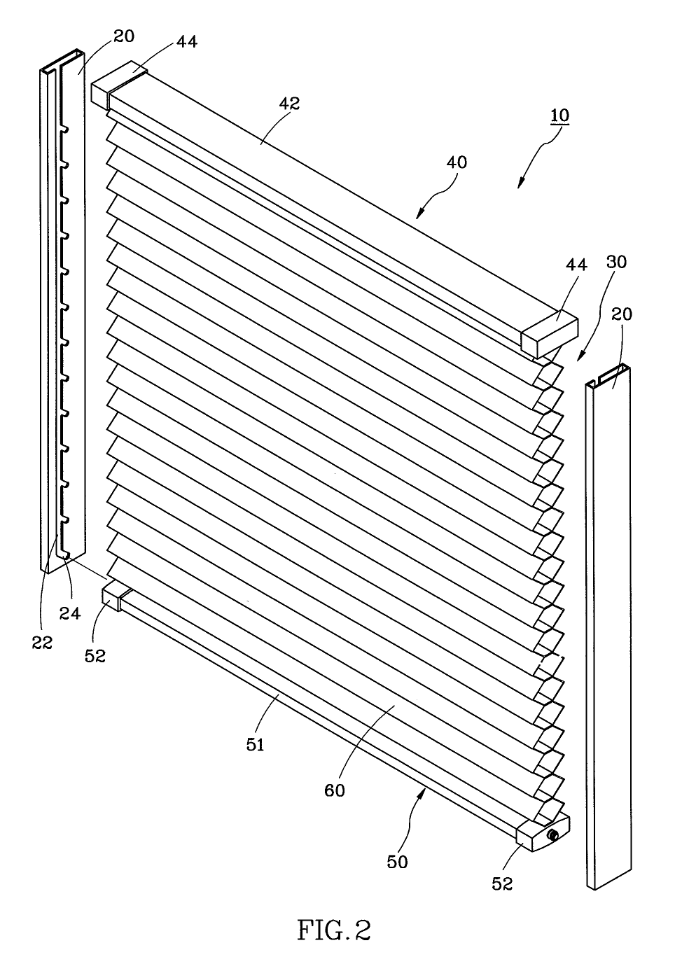

Referring to FIGS. 1 and 2, a non-cord window blind assembly 10 in accordance with the present invention is shown. As illustrated, the non-cord window blind assembly 10 comprises two side jambs 20 and a blind 30.

The two side jambs 20 are fixedly mounted in a wall in a mirror-symmetric manner, each defining a guide groove 22 and a plurality of oblique positioning grooves 24 in one side thereof. The guide groove 22 extends along the length of the respective side jamb 20. The oblique positioning grooves 24 are equally spaced along the length of the respective side jamb 20. Further, each oblique positioning groove 24 has one end thereof connected to the guide groove 22 and its other end extended obliquely downwardly away from the guide groove 22.

The blind 30 can be made in the form of a cellular blind or venetian blind. In this embodiment, the blind 30 is a cellular blind. However, this example is not a limitation. The blind 30 is set between the two side jambs 20, comprising a headrail 40, a bottom rail 50, and a panel of cellular material 60. The headrail 40 comprises a headrail body 42, and two upper end caps 44 respectively capped two opposite ends of the headrail body 42 and respectively stopped at the top ends of the side jambs 20. The bottom rail 50 comprises a bottom rail body 51, and two bottom end caps 52 respectively capped on two opposite ends of the bottom rail body 51. In this embodiment, each bottom end cap 52 defines therein a through hole 53. Further, a weight 54 is mounted in the bottom rail body 51, having two opposite ends thereof respectively terminating in a respective guide rod 55. The guide rods 55 of the weight 54 are respectively inserted through the through holes 53 in the bottom end caps 52 into the guide grooves 22 of the side jambs 20. The bottom rail 50 further comprises two pulleys 56 respectively fastened to the guide rods 55 of the weight 54 with a respective retaining ring 57 and respectively rotatably mounted in the guide grooves 22 of the side jambs 20 to enhance the smoothness and stability of upward and downward movement of the bottom rail 50. The panel of cellular material 60 is coupled between the headrail body 42 of the headrail 40 and the bottom rail body 51 of the bottom rail 50, and adapted to provide shading, thermal insulation and dust protection effects.

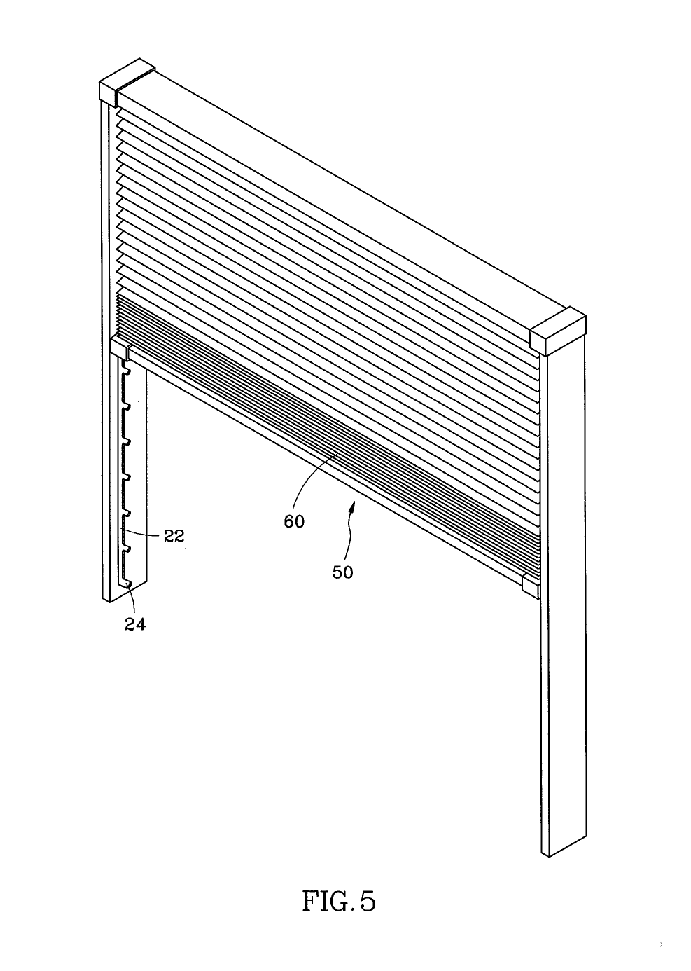

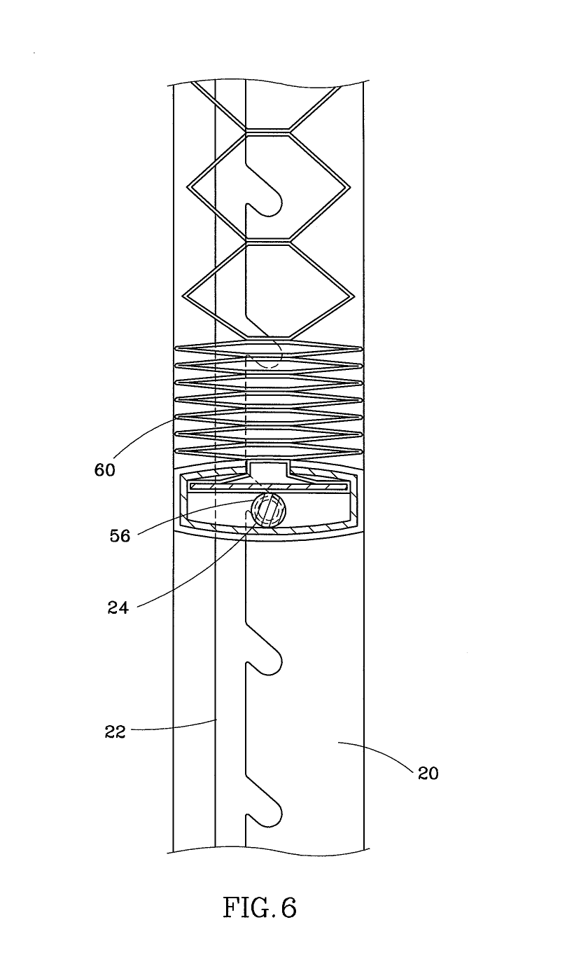

When going to receive the panel of cellular material 60 in the received condition, as shown in FIGS. 5 and 6, force the bottom rail 50 to move the pulleys 56 out of the respective oblique positioning grooves 24 into the respective guide grooves 22, and then push the bottom rail 50 upward to move the pulleys 56 upwardly along the respective guide grooves 22. At this time, the panel of cellular material 60 will be moved upwards and gradually received. As soon as the panel of cellular material 60 reaches the desired height, force the bottom rail 50 to move the pulleys 56 into the respective adjacent oblique positioning grooves 24 around the desired height, and thus the panel of cellular material 60 is set in position.

When going to extend out the panel of cellular material 60, force the bottom rail 50 to move the respective pulleys 56 out of the respective oblique positioning grooves 24 into the respective guide grooves 22, and then pull the bottom rail 50 to move the pulleys 56 downwardly along the respective guide grooves 22. At this time, the panel of cellular material 60 will be moved with the bottom rail 50 downwards and gradually extended out. As soon as the panel of cellular material 60 reaches the desired height, force the bottom rail 50 to move the pulleys 56 into the respective adjacent oblique positioning grooves 24 around the desired height, and thus the panel of cellular material 60 is set in position.

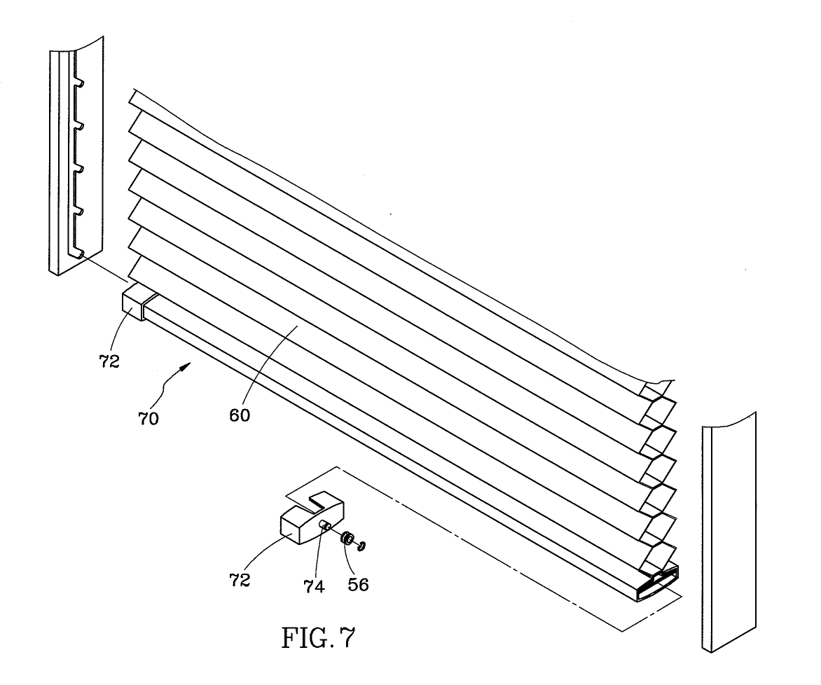

Further, the bottom rail can be various embodied. In a second embodiment of the present invention, as shown in FIG. 7, the bottom rail 70 eliminates the aforesaid weight 54; each bottom end cap 72 provides a guide rod 74 for holding one respective pulley 56. Thus, the functioning of the pulleys 56 enable the panel of cellular material 60 to be smoothly moved between an extended out position and a received position. When compared to the aforesaid first embodiment, this second embodiment has a relative simple structure.

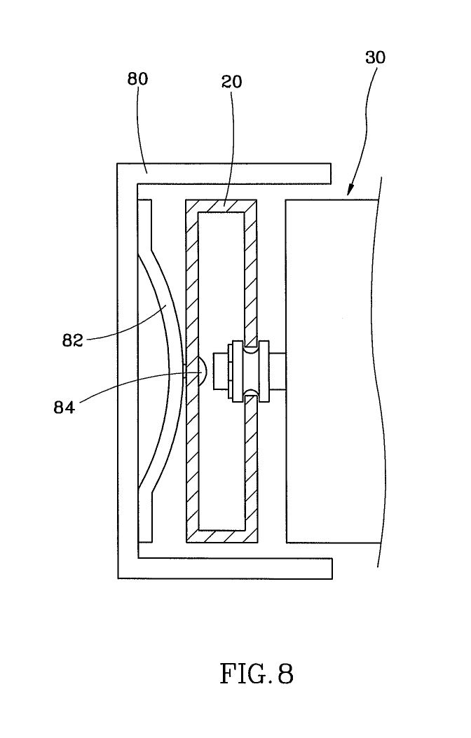

Further, it is to be noted that after the panel of cellular material 60 is received in the desired received condition and set in position, the bottom rail 50 and the part of the panel of cellular material 60 adjacent to the bottom rail 5 can turn over due to weight imbalance. In order to eliminate this problem, a non-cord window blind assembly in accordance with a third embodiment of the present invention. As illustrated in FIG. 8, the non-cord window blind assembly 10 of this third embodiment further comprises two outer frames 80 affixed to a wall in a mirror-symmetric manner, and two spring members 82 respectively mounted in the two outer frames 80. During installation, the opposing left and right sides with the two side jambs 20 are respectively accommodated in the outer frames 80, enabling each side jamb 20 to be affixed to one respective spring member 82 with one respective screw 84. This arrangement effectively prevents the bottom rail 50 and the panel of cellular material 60 from turning over. Further, the gap between each side jamb 20 and the respective outer frame 80 is adjustable by fastening tight or loosening the respective screw 84, maintaining the best condition of use.

In conclusion, the non-cord window blind assembly 10 of the invention enables the panel of cellular material 60 to be extended out or received subject to guidance and coupling between the side jambs 20 and the bottom rail 50/70, eliminating the technique of the prior art design to provide a transmission mechanism in the headrail. When compared to the prior art design, the structure of the present invention is more simple and more easy to operate, and therefore, the invention can effectively reduce the manufacturing cost and enhance user convenience.

1. A non-cord window blind assembly, comprising:
two side jambs in a minor-symmetric manner, each said side jamb comprising a guide groove extending along the length thereof and a plurality of oblique positioning grooves equally spaced along the length thereof and respectively connected to said guide groove; and
a blind coupled between said side jambs, said blind comprising a headrail, a bottom rail and a panel of cellular material connected between said headrail and said bottom rail, said bottom rail comprising two guide rods respectively located at two opposite ends thereof and respectively slidably coupled to the guide grooves of said side jambs and respectively selectively positionable in one respective said oblique positioning groove of one respective said side jamb.

2. The non-cord window blind assembly as claimed in claim 1, wherein said bottom rail comprises a bottom rail body connected with said panel of cellular material, and two bottom end caps respectively capped on two opposite ends of said bottom rail body, each said bottom end cap providing one said guide rod.

3. The non-cord window blind assembly as claimed in claim 2 wherein each said guide rod at one respective said bottom end cap is mounted with one respective pulley, said pulley being rotatably coupled to the guide groove of one respective said side jamb and selectively positionable in one said oblique positioning groove of the respective said side jamb.

4. The non-cord window blind assembly as claimed in claim 1, wherein said bottom rail comprises a bottom rail body connected with said panel of cellular material, two bottom end caps respectively capped on two opposite ends of said bottom rail body, each said end cap defining therein a through hole, and a weight mounted in said bottom rail body, said weight having two opposite ends thereof respectively terminating in one respective said guide rod, each said guide rod being inserted through the through hole of the respective said bottom end cap into the guide groove of one respective said side jamb.

5. The non-cord window blind assembly as claimed in claim 4, wherein each said guide rod of said bottom rail has a respective pulley mounted thereon, said pulley being rotatably coupled to the guide groove of one respective said side jamb and selectively positionable in one said oblique positioning groove of the respective said side jamb.

6. The non-cord window blind assembly as claimed in claim 1, further comprising two outer frames arranged in a mirror-symmetric manner and adapted to accommodate two opposite sides of said blind and said two side jambs.

7. The non-cord window blind assembly as claimed in claim 6, further comprising two spring members respectively mounted in said outer frames, and two screws respectively affixing said side jambs to said spring members.
